(19) United States
(12) Patent Application Publication
(10) Pub. No.: US 2015/0331624 A1
(43) Pub. Date: Nov. 19, 2015

(54) HOST-CONTROLLED FLASH TRANSLATION LAYER SNAPSHOT

(71) Applicant: KABUSHIKI KAISHA TOSHIBA, Tokyo (JP)

(72) Inventor: Sie Pook LAW, San Jose, CA (US)

(73) Assignee: KABUSHIKI KAISHA TOSHIBA, Tokyo (JP)

(21) Appl. No.: 14/281,318

(22) Filed: May 19, 2014

(51) Int. Cl. G06F 3/06; G06F 12/10

(52) U.S. Cl. CPC G06F 3/0619; G06F 12/10; G06F 3/065; G06F 3/0652; G06F 3/0688; G06F 2212/1032; G06F 2212/152; G06F 2212/2022; G06F 2212/214; G06F 2212/261; G06F 2212/7201; G06F 2212/7205

(57) ABSTRACT

A flash translation layer (FTL) map stored in the non-volatile portion of a solid-state drive is updated when a firmware flag indicates the contents of this FTL map are not consistent with the contents of an FTL map stored in a volatile memory device of the SSD (e.g., the drive DRAM). Given this flag indication, the solid-state drive may copy the contents of the FTL map stored in the drive DRAM to the non-volatile portion of the SSD under various circumstances, including when a host command to flush the updated data structure is received, when a link state between the data storage device and the host changes, when a power connection to the data storage device is broken, or upon receiving a host command to go into a sleep state or a lower power state.

### BACKGROUND

In enterprise data storage and distributed computing systems, banks or arrays of data storage devices are commonly employed to facilitate large-scale data storage for a plurality of hosts or users. Because latency is a significant issue in such computing systems, solid-state drives (SSDs) are commonly used as data storage devices. To facilitate retrieval of data stored in an SSD, stored data are typically mapped to particular physical storage locations in the SSD using a mapping data structure. For example, the mapping data structure may be an associative array that pairs each logical block address (LBA) stored in the SSD with the physical memory location that stores the data associated with the LBA. Such a mapping data structure, sometimes referred to as the flash translation layer map (FTL map), can be a very large file, for example on the order of a gigabyte or more. Consequently, to minimize latency associated with reading and/or updating the FTL map, the most up-to-date version of the FTL map typically resides in the dynamic read only memory (DRAM) of the SSD, and is only updated to a non-volatile portion of the SSD periodically in a process known as “snapshotting,” “checkpointing,” or “checkpoint writing.”

While snapshotting may be used to save any data to persistent storage periodically, snapshotting an FTL map can adversely affect performance of the SSD, specifically the effective bit rate of the SSD. Because the FTL map is generally a very large file, copying this file to a non-volatile portion of the SSD can noticeably impact the effective SSD bit rate; as SSD resources are allocated for performing the large file copy, other read and write commands to the SSD may be queued, thereby significantly lowering the bit rate of accesses to the SSD while the FTL map is snapshot. Thus, for an SSD specified to accept, for example, 500 megabytes per second (MBps), the actual performance of the SSD while the FTL map is snapshot may drop to 100 MBps or less.

### SUMMARY

One or more embodiments provide systems and methods for host-controlled snapshotting of a flash translation layer map (FTL map) for a solid-state drive (SSD). In one embodiment, a non-volatile FTL map stored in the non-volatile portion of the SSD is only updated when a firmware flag indicates the contents of this FTL map are not consistent with the contents of a volatile FTL map stored in a volatile memory device of the SSD (e.g., the drive DRAM). Given this flag indication, the SSD may copy the contents of the volatile FTL map to the non-volatile portion of the SSD under various circumstances, including when a host command to flush the updated data structure is received, when a link state between the data storage device and the host changes, when a power connection to the data storage device is broken, or upon receiving a host command to go into a sleep state or a lower power state.

A data storage device, according to embodiments, comprises a non-volatile solid-state device, a volatile solid-state memory device, and a controller. In one embodiment, the volatile solid-state memory device is configured to store a data structure that maps logical block addresses stored in the data storage device to respective physical memory locations in the non-volatile solid-state storage device. In the embodiment, the controller is configured to, upon updating the data structure, determine whether a host command to flush the updated data structure has been received and, if the host command to flush the updated data structure has been received, copy the contents of the updated data structure into the non-volatile solid-state device.

Further embodiments provide a method of operating a storage device that includes a non-volatile solid-state device and a volatile solid-state memory device that is configured to store a first data structure that maps logical block addresses stored in the data storage device to respective physical memory locations in the non-volatile solid-state storage device. The method comprises the steps of determining whether the contents of the first data structure are consistent with the contents of a corresponding second data structure stored in the non-volatile solid-state storage device, based on the contents of the first data structure being consistent with the contents of the corresponding second data structure, determining whether a host command to flush the first data structure has been received, and, if the host command to flush the first data structure have been received, copying the contents of the first data structure into the non-volatile solid-state device.

### BRIEF DESCRIPTION OF THE DRAWINGS

FIG. 1 illustrates an operational diagram of a solid-state drive configured according to one embodiment.

FIG. 2A depicts a timeline of events that may occur during operation of a typical solid-state drive employed in an enterprise data storage system or a distributed computing system.

FIG. 2B depicts a timeline indicating an effective data rate of communications between a host and a solid-state drive in relation to the events shown in FIG. 2A.

FIG. 3A depicts a timeline of events that may occur during operation of the solid-state drive of FIG. 1 according to some embodiments.

FIG. 3B depicts a timeline indicating an effective data rate of communications between a host and the solid-state drive in FIG. 1 in relation to the events shown in FIG. 3A, according to some embodiments.

FIG. 4 sets forth a flowchart of method steps for operating a storage device that includes a non-volatile solid-state device and a volatile solid-state memory device configured to store a data structure that maps logical block addresses stored in the data storage device to respective physical memory locations in the non-volatile solid-state storage device, according to one or more embodiments.

### DETAILED DESCRIPTION

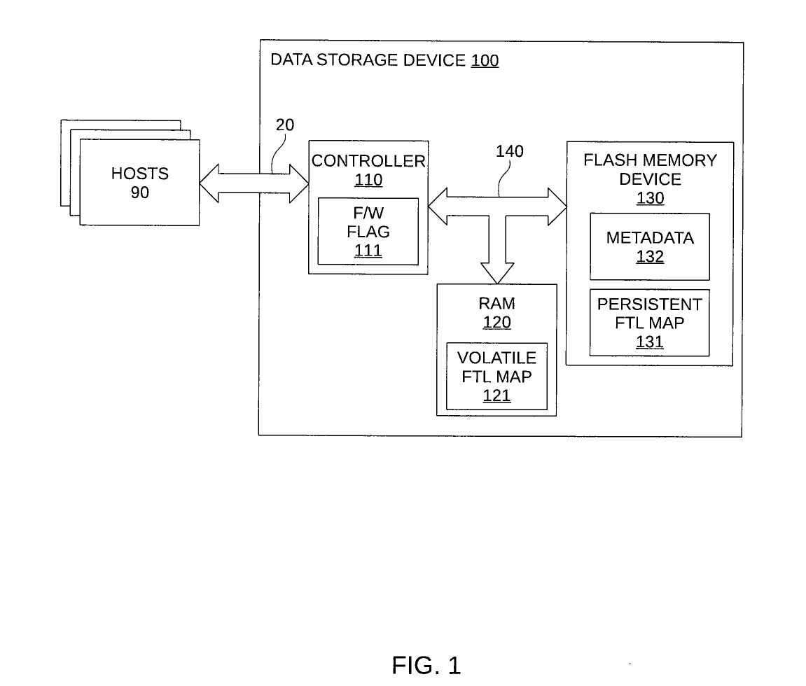

FIG. 1 illustrates an operational diagram of a solid-state drive (SSD) 100 configured according to one embodiment. As shown, SSD 100 includes a drive controller 110, a random access memory (RAM) 120, a flash memory device 130, and a high-speed data path 140. SSD 100 may be a data storage device of an enterprise data storage system or a distributed (cloud) computing system. As such, SSD 100 is connected to one or more hosts 90, such as a host computer or cloud computing customer, via a host interface 20. In some embodiments, host interface 20 may include any technically feasible system interface, including a serial advanced technology attachment (SATA) bus, a serial attached SCSI (SAS) bus, a non-volatile memory express (NVMe) bus, and the like. Alternatively or additionally, in some embodiments, host interface 20 may include a wired and/or wireless communications link implemented as part of an information network, such as the Internet and/or any other suitable data network system. High-speed data path 140 may be any high-speed bus known in the art, such as a double data rate (DDR) bus, a DDR2 bus, a DDR3 bus, or the like.

Drive controller 110 is configured to control operation of SSD 100, and is connected to RAM 120 and flash memory device 130 via high-speed data path 140. Drive controller 110 may also be configured to control interfacing of SSD 100 with the one or more hosts 90. Some or all of the functionality of drive controller 110 may be implemented as firmware, application-specific integrated circuits, and/or a software application. In some embodiments, drive controller 110 includes a firmware flag 111, such as a status register, that indicates whether the contents of a volatile flash translation layer map (FTL map) 121 are consistent with the contents of a corresponding data structure stored in flash memory device 130 (i.e., a non-volatile FTL map 131). For example, when the contents of volatile FTL map 121 are modified during operation of SSD 100, firmware flag 111 is set to indicate that the contents of non-volatile FTL map 131 are not consistent with the contents of volatile FTL map 121. Conversely, when the contents of volatile FTL map 121 are copied into flash memory device 130 as the current version of non-volatile FTL map 131, firmware flag 111 is set to indicate the contents of non-volatile FTL map 131 are consistent with the contents of volatile FTL map 121. volatile FTL map 121 and non-volatile FTL map 131 are described below.

As used herein, a “volatile” FTL map refers to an FTL map that is stored in a volatile memory device, such as RAM 120, and as such the data included in a volatile FTL map is lost or destroyed when SSD 100 is powered off or otherwise disconnected from a power source. Similarly, as used herein, a “non-volatile” FTL map refers to an FTL map that is stored in a non-volatile memory device, such as flash memory device 130, and as such the data included in a non-volatile FTL map is not lost or destroyed when SSD 100 is powered off or otherwise disconnected from a power source.

RAM 120 is a volatile solid-state memory device, such as a dynamic RAM (DRAM). RAM 120 is configured for use as a data buffer for SSD 100, temporarily storing data received from hosts 90. In addition, RAM 120 is configured to store volatile FTL map 121. Volatile FTL map 121 is a data structure that maps logical block addresses (LBAs) stored in SSD 100 to respective physical memory locations (e.g., memory addresses) in flash memory device 130. To reduce latency associated with SSD 100 and to extend the lifetime of flash memory device 130, volatile FTL map 121 includes the most up-to-date mapping of LBAs stored in SSD 100 to physical memory locations in flash memory device 130. Latency associated with SSD 100 is reduced because reads from RAM 120 in response to a command from host 90 are generally faster than reads from flash memory device 130. Lifetime of flash memory device 130 is extended by modifying volatile FTL map 121 during normal operation of SSD 100 and only periodically replacing non-volatile FTL map 131 in flash memory 130; constantly updating non-volatile FTL map 131 results in significant wear to the memory cells of flash memory 130.

Flash memory device 130 is a non-volatile solid-state storage medium, such as a NAND flash chip, that can be electrically erased and reprogrammed. For clarity, SSD 100 is illustrated in FIG. 1 with a single flash memory device 130, but in actual implementations, SSD 100 may include one or multiple flash memory devices 130. Flash memory device 130 is configured to store non-volatile FTL map 131, as shown. Similar to virtual FTL map 121 stored in RAM 120, non-volatile FTL map 131 is a data structure that maps LBAs stored in SSD 100 to respective physical memory locations in flash memory device 130. Because the contents of non-volatile FTL map 131 are stored in flash memory device 130, said contents are not lost or destroyed after powering down SSD 100 and after power loss to SSD 100.

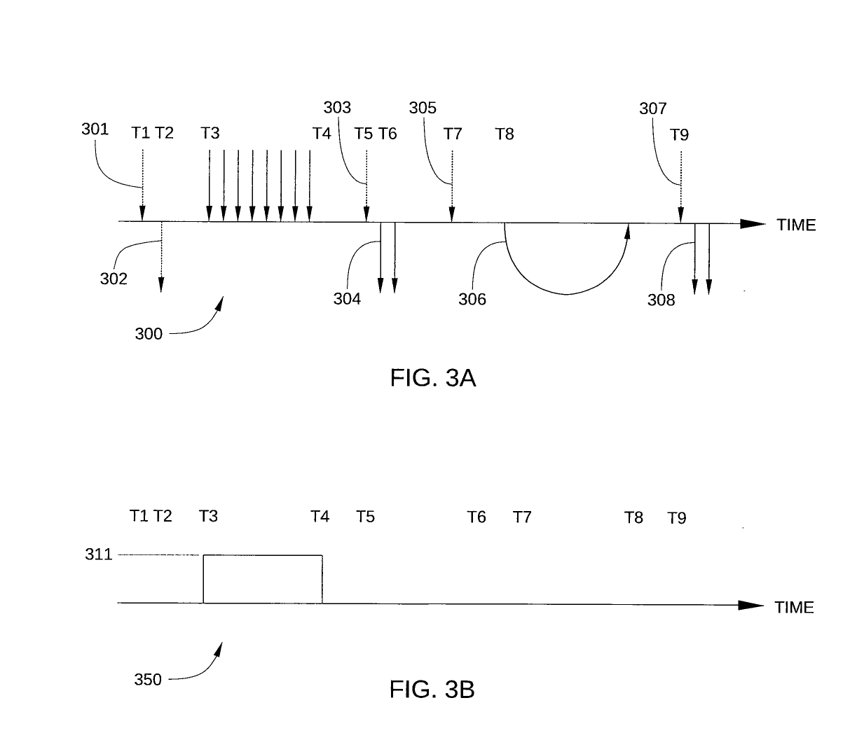

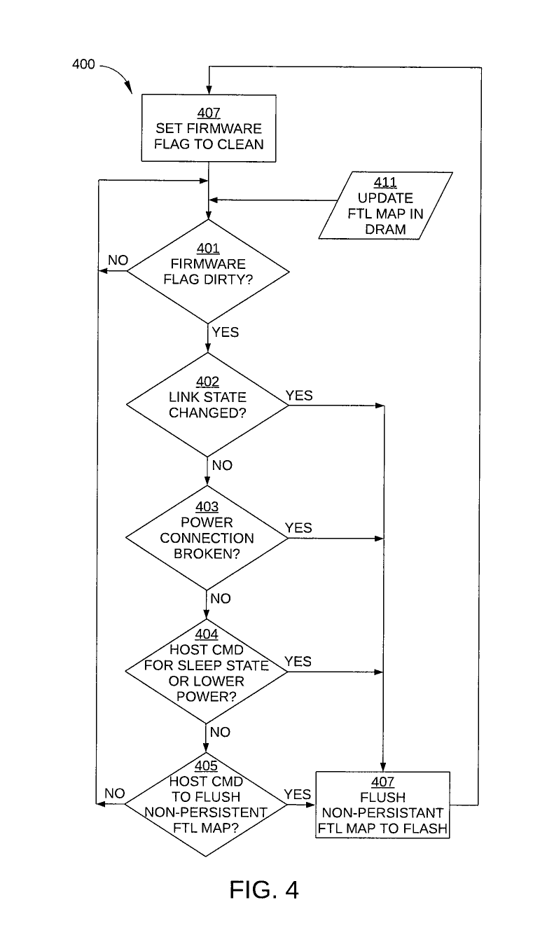

In some embodiments, flash memory device 130 is further configured to store metadata 132. Metadata 132 includes descriptor data for FTL map 131, indicating what physical memory locations in flash memory device 130 are used to store FTL map 131. Specifically, under certain circumstances (described below in conjunction with FIGS. 3A, 3B, and 4) the contents of volatile FTL map 121 are “checkpointed” or “snapshot,” i.e., copied into flash memory device 130 as the current version of FTL map 131. Drive controller 110 or a flash manager module (not shown) associated with flash memory device 130 then modifies metadata 132 to point to the physical memory locations in flash memory device 130 that store the newly copied contents of volatile FTL map 121. Thus the former contents of FTL map 131 are no longer associated therewith, and may be considered obsolete or invalid data.

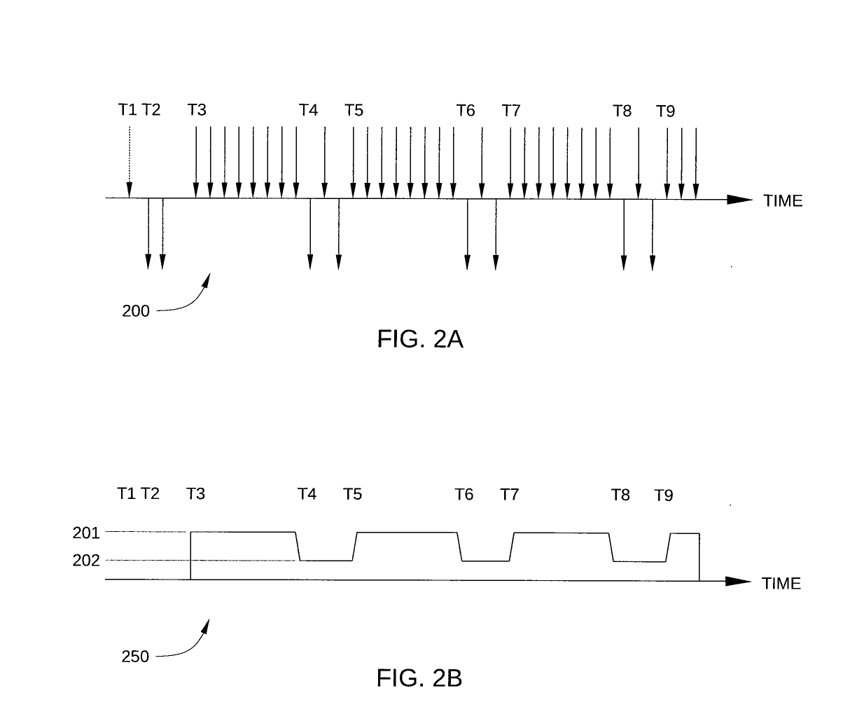

Periodically checkpointing an FTL map to a non-volatile portion of the SSD, as in a conventional SSD, can adversely affect performance of the SSD. According to typical conventional schemes, the FTL map is typically checkpointed at fixed intervals (either time intervals or write-command intervals), and therefore may occur concurrently with activities being performed by the SSD in response to host commands. Consequently, the time required for the SSD to respond to host commands (i.e., read or write latency) may be increased. FIGS. 2A and 2B illustrate scenarios in which checkpointing an FTL map to a non-volatile portion of an SSD adversely affects performance of the SSD.

FIG. 2A depicts a timeline 200 of events that may occur during operation of a typical SSD employed in an enterprise data storage system or a distributed computing system. FIG. 2B depicts a timeline 250 indicating an effective data rate of communications between a host and the SSD in relation to the events shown in FIG. 2A. The communications between the host and the SSD may include data transfer, host commands, communication link status messages, and the like.

At time T1, the SSD receives status messages via a system interface, such as a SATA, SAS, or NVMe bus, indicating that a communications link has been established between the host and the SSD. At time T2, the SSD “checkpoints” or “snapshots” the most up-to-date version of FTL map for the drive, which resides in DRAM, into a non-volatile portion of the drive, generally flash memory. The SSD performs the snapshot at time T2 as part of a typical checkpoint policy, i.e., snapshotting whenever a communications link is established between the host and the SSD. At time T3, the SSD receives a host write command and begins writing data to flash memory. As illustrated in FIG. 2B, the data rate of communications between the host and the SSD is maintained at or above a specified level 201, for example 500 megabytes per second (MBps), until time T4. As data are written to the flash memory of the SSD, the FTL map residing in the SSD DRAM is updated, so that the data written to flash memory can be subsequently read. At time T4, the SSD performs another snapshot of the FTL map residing in DRAM, and the snapshot process continues until time T5. For example, the quantity of data written to flash memory between times T3 and T4 may exceed a predetermined threshold, thereby triggering a snapshot of the FTL map in SSD DRAM. Alternatively, time T4 may correspond to a predetermined time at which the SSD is configured to perform a checkpoint of the FTL map in SSD DRAM. In either case, the SSD is configured to perform such a snapshot regardless of whatever host-SSD activity is currently underway at time T4.

Because the FTL map stored in SSD DRAM can be a large file, for example on the order of a gigabyte (GB) or more, the effective data rate of communications between the host and the SSD drops significantly during the time that the snapshot process is underway (i.e., from time T4 to time T5). For example, the effective data rate may drop from 500 MBps to a reduced level 202 (shown in FIG. 2B) of 200 MBps, 100 MBps, or even less. Such a drop in effective data rate is highly undesirable, since the SSD is configured as part of an enterprise data storage system or distributed computing system, and therefore may have strict latency maximum and/or data rate minimum requirements.

At time T5, after the SSD completes snapshotting the FTL map that is in DRAM into flash memory, the SSD continues with the series of write commands received from the host, and the effective data rate of the SSD returns to specified level 201. However, the reduction in effective data rate of the SSD drops to reduced level 202 whenever the predetermined threshold is exceeded that triggers a snapshot of the FTL map in SSD DRAM. For example, at time T6 and time T8, said threshold is exceeded, the SSD snapshots the FTL map that is in DRAM to flash memory, and the effective data rate of communications between the SSD and the host again drops to reduced level 202 between times T6 and T7 and between times T8 and T9. In this way, the contents of the most up-to-date FTL map for the SSD, which resides in the SSD DRAM, is periodically copied to flash memory, so that the current mapping of LBAs stored in the SSD 100 to physical memory locations in flash memory of the SSD are captured in a non-volatile state and cannot be lost due to unexpected power loss to the SSD.

In one or more embodiments, an FTL map stored in the non-volatile portion of an SSD is only updated when a firmware flag indicates that the contents of this FTL map are not consistent with the contents of the most up-to-date FTL map of the SSD, which is stored in a volatile memory device of the SSD (e.g., the drive DRAM). FIG. 3A depicts a timeline 300 of events that may occur during operation of SSD 100 of FIG. 1 according to such embodiments. FIG. 3B depicts a timeline 350 indicating an effective data rate of communications between host 90 and SSD 100 in relation to the events shown in FIG. 2A, according to some embodiments. The communications between host 90 and SSD 100 may include data transfer, host commands, communication link status messages, and the like.

At time T1, SSD 100 receives status messages 301 via a system interface, such as a SATA, SAS, or NVMe bus, indicating that a communications link has been established between the host and the SSD. At time T2, drive controller 110 performs a check 302 of firmware flag 111 to determine whether the contents of FTL map 131 are consistent with the contents of volatile FTL map 121 stored in RAM 120. In the scenario illustrated in FIG. 3A, firmware flag 111 indicates that the respective contents of volatile FTL map 121 and FTL map 131 are consistent; therefore the contents of volatile FTL map 121 are not copied into flash memory device 130. Consequently, SSD 100 is immediately available for communications with host 90 at or above a specified level 311, since SSD 100 does not automatically perform a checkpoint of volatile FTL map 121. In embodiments in which SSD 100 is employed in an enterprise data storage system or a distributed computing system, specified level 311 may be a minimum guaranteed data rate committed to a customer by a provider of SSD 100. Furthermore, significant wear of SSD 100 is prevented at time T2, since a snapshot of volatile FTL map 121 is not automatically performed whenever a communications link is established with host 90. Thus, the FTL map stored in flash memory device 130 (i.e., FTL map 131) is not replaced with an identical FTL map from RAM (i.e., volatile FTL map 121).

At time T3, SSD 100 receives a write command from host 90 and begins writing data to flash memory device 130. As illustrated in FIG. 3B, the data rate of communications between host 90 and SSD 100 is maintained at or above specified level 311, for example 500 MBps, until time T4, when the writing is complete. As data are written to flash memory device 130, volatile FTL map 121 is continuously updated, so that the data written to flash memory 130 can be subsequently read. In addition, as soon as or slightly after volatile FTL map 121 is updated at time T3, firmware flag 111 is set to indicate that the contents of FTL map 131 are no longer consistent with the contents of volatile FTL map 121. However, according to some embodiments, SSD 100 does not perform a snapshot of volatile FTL map 121 until an additional condition is met, including: a host command to “flush” volatile FTL map 121 is received (i.e., save the contents of volatile FTL map 121 in a non-volatile data storage medium of SSD 100); a link state between SSD 100 and host 90 has been broken; a host command to go into a sleep state or a lower power state has been received; or a power connection to SSD 100 has been broken, among others. Thus, because the write commands from host 90 can be executed without interruption by snapshotting volatile FTL map 121, SSD 100 can maintain an effective data rate of at least specified level 311.

At time T5, SSD 100 receives a command 303 from host 90 to synchronize the contents of FTL map 121 with the contents of FTL map 131, i.e., to “flush” the contents of FTL map 121, or perform a snapshot of volatile FTL map 121. In some embodiments, command 303 may be implemented as a particular field of a system interface command. For example, the system interface command may be a SATA flush cache command, a SATA standby immediate command, a SAS synchronize cache command, an NVMe flush command, or an NVMe shutdown notification command. At time T6, drive controller 110 checks firmware flag 111 and, if firmware flag 111 indicates that the contents of FTL map 131 are not consistent with the contents of volatile FTL map 121, drive controller 100 performs a snapshot 304 of FTL map 121, as shown. After performing snapshot 304, drive controller 110 updates firmware flag 111 to indicate the contents of FTL map 131 are consistent with the contents of volatile FTL map 121. Because host 90 can control when SSD 100 performs snapshot 304 of volatile FTL map 121, host 90 can time snapshot 304 to occur during time intervals in which SSD 100 is idle. In this way, the effective data rate of SSD 100 is not degraded to a reduced data rate below specified level 311 during write operations.

At time T7, SSD 100 receives a communication link down indication 305, which may be a link status message signaling that host interface 20 is down. Alternatively or additionally, communication link down indication 305 may include failure to receive a link status message signaling that host interface 20 is functioning. Upon receiving communication link down indication 305, drive controller 110 checks firmware flag 111 and, if firmware flag 111 indicates that the contents of FTL map 131 are not consistent with the contents of volatile FTL map 121, drive controller 110 performs a snapshot of FTL map 121. In the scenario illustrated in FIG. 3A, the contents of volatile FTL map 121 have not been updated since snapshot 304, therefore at time T7, firmware flag 111 is still set to indicate the contents of FTL map 131 are consistent with the contents of volatile FTL map 121. Thus, no snapshot of volatile FTL map 121 is performed at time T7.

Because drive controller 110 checks firmware flag 111 at time T7 (i.e., upon receipt of communication link down indication 305) before performing a snapshot of volatile FTL map 121, significant wear of flash memory device can be avoided. For example, in enterprise storage and cloud computing applications, host interface 20 may experience instabilities that cause SSD 100 to receive communication link down indication 305 many times in a relatively short time interval as host interface 20 repeatedly drops out and is re-established. Without a snapshot of volatile FTL map 121 being contingent on a check of firmware flag 111, the contents of volatile FTL map 121 would be repeatedly copied to flash memory device 130, even though identical to the contents of FTL map 131.

In some embodiments, firmware flag 111 is updated as a result of operations internal to SSD 100 and independent of write commands received from host 90. For example, at time T8 SSD 100 may perform a garbage collection operation 306 as a background operation while otherwise idle. Garbage collection operation 306 involves consolidating blocks of flash memory in flash memory device 130 by reading data from partially filled flash memory blocks and rewriting the data to complete blocks of flash memory. Garbage collection operation 306 involves relocating data stored in flash memory device 130, which necessitates updating volatile FTL map 121 even though a write command from host 90 is not executed. Thus, once SSD 100 has begun garbage collection, volatile FTL map 121 is updated accordingly, firmware flag 111 is set to indicate that the contents of FTL map 131 are not consistent with the contents of FTL map 121, and SSD 100 will perform a snapshot of virtual FTL map when a particular additional condition is met. Examples of such additional conditions include: receipt of command 303 from host 90 to flush volatile FTL map 121; receipt of communication link down indication 305; receipt of a command from host 90 to go into a sleep state or a lower power state; and receipt of a power connection broken indicator 307, among others.

By way of example, at time T9 (i.e., sometime after completion of garbage collection operation 306), SSD 100 receives power connection broken indicator 307 and performs a snapshot 308 of volatile FTL map 121. Power connection broken indicator 307 may be any status message or other indicator that drive controller 110 uses to determine that a power connection to SSD 100 has been broken. Alternatively or additionally, power connection broken indicator 307 may be the failure of drive controller 110 to receive a status message that drive controller 110 employs to determine that a power connection to SSD 100 is currently established. Because at time T9 no snapshot of volatile FTL map 121 has taken place since garbage collection operation 306, firmware flag 111 is set to indicate that the contents of FTL map 131 are not consistent with volatile FTL map 121. Consequently, at time T9, drive controller 110 performs snapshot 308 as shown. It is noted that to facilitate the execution of snapshot 308 after power connection broken indicator 307 is received (and therefore a power connection to SSD 100 is broken), SSD 100 may be coupled to an auxiliary power source, such as a capacitor, battery, or the like.

FIG. 4 sets forth a flowchart of method steps for operating a storage device that includes a non-volatile solid-state device and a volatile solid-state memory device configured to store a data structure that maps logical block addresses stored in the data storage device to respective physical memory locations in the non-volatile solid-state storage device, according to one or more embodiments. Although the method steps are described in conjunction with SSD 100 in FIG. 1, persons skilled in the art will understand the method steps may be performed with other types of data storage devices. While described below as performed by drive controller 110, control algorithms for the method steps may reside in and/or be performed by a flash manager device for flash memory device 130 or any other suitable control circuit or system associated with SSD 100.

As shown, a method 400 begins at step 401, in which drive controller 110 determines whether the contents of volatile FTL map 121 are “clean” (consistent with the contents of FTL map 131) or “dirty” (more up-to-date and not consistent with the contents of FTL map 131). In other words, drive controller 110 checks the setting of firmware flag 111. If firmware flag 111 indicates that the contents of volatile FTL map 121 are dirty, method 400 proceeds to step 402. As described above, firmware flag 111 is set to dirty in response to volatile FTL map 121 being updated, for example due to a garbage collection operation, a write command from host 90 being executed, etc. (shown in step 411). If firmware flag 111 indicates that the contents of volatile FTL map 121 are clean (i.e., consistent with the contents of FTL map 131), method 400 returns to step 401, and drive controller 110 continues to periodically perform step 401, for example as part of a polling operation.

In step 402, drive controller 110 determines whether a link state between SSD 100 and host 90 has changed. For example, in one embodiment, drive controller 110 determines that host interface 20 is down. If such a change is detected in step 402, method 400 proceeds to step 406. If such a change is not detected in step 402, method 400 proceeds to step 403.

In step 403, drive controller 110 determines whether a power connection for SSD 100 has been broken. If such a broken power connection is detected in step 403, method 400 proceeds to step 406. If such a broken power connection is not detected in step 403, method 400 proceeds to step 404.

In step 404, drive controller 110 determines whether a host command to go into a sleep state or a lower power state has been received. If receipt of such a host command is detected in step 404, method 400 proceeds to step 406. If receipt of such a host command is not detected in step 404, method 400 proceeds to step 405.

In step 405, drive controller 110 determines whether a host command to flush volatile FTL map 121 to flash memory device 130 has been received. If receipt of such a host command is detected in step 405, method 400 proceeds to step 406. If receipt of such a host command is not detected in step 405, method 400 returns back to step 401 as shown.

In step 406, drive controller 110 flushes the contents of volatile FTL map 121 to flash memory device 130. Thus, upon completion of step 406, the contents of volatile FTL map 121 are clean, since they are the most up-to-date FTL map for SSD 100 and are consistent with the contents of FTL map 131.

In step 407, drive controller 110 sets firmware flag 111 to clean, indicating that the contents of FTL map 131 are consistent with the contents of volatile FTL map 121.

In some embodiments, one or more of hosts 90 are configured to facilitate method 400. For example, one or more of hosts 90 may be configured to send a flush FTL map command using, for example, a field in an existing host interface command. In this way, a host 90 so configured can control when SSD 100 performs a snapshot of volatile FTL map 121. Alternatively or additionally, one or more of hosts 90 may be configured to enable or disable the functionality of SSD 100 described above in conjunction with FIG. 4 using, for example, a field in an existing host interface command. Alternatively or additionally, one or more of hosts 90 may be configured to read back the current status of SSD 100 with respect to the functionality described above in conjunction with FIG. 4. Thus, a host 90 can determine whether a flush FTL map command will be accepted and executed by SSD 100. In such embodiments, host 90 may use, for example, a field in an existing host interface command to request such information from SSD 100.

In sum, embodiments described herein provide systems and methods for operating an SSD that includes a non-volatile solid-state device and a volatile solid-state memory device. An FTL map stored in the non-volatile portion of the SSD is only updated when a firmware flag indicates the contents of this FTL map are not consistent with the contents of an FTL map stored in the volatile memory device of the SSD. Application of this firmware flag as a condition for performing a snapshot of the volatile FTL map improves performance of the SSD and reduces wear associated with unnecessary writes of an FTL map to the non-volatile solid-state device.

While the foregoing is directed to embodiments of the present invention, other and further embodiments of the invention may be devised without departing from the basic scope thereof, and the scope thereof is determined by the claims that follow.

I claim:

1. A data storage device comprising:
a non-volatile solid-state storage device;
a volatile solid-state memory device configured to store a data structure that maps logical block addresses stored in the data storage device to respective physical memory locations in the non-volatile solid-state storage device; and
a controller configured to: (i) upon updating the data structure, determine whether a host command to flush the updated data structure has been received, and (ii) if the host command to flush the updated data structure has been received, copy the contents of the updated data structure into the non-volatile solid-state device.

2. The data storage device of claim 1, wherein the controller is further configured to, upon updating the data structure, update a flag to indicate that the contents of the data structure are not consistent with the contents of a corresponding data structure stored in the non-volatile solid-state device.

3. The data storage device of claim 1, wherein the physical memory locations respectively store data associated with a respective logical block address stored in the data storage device.

4. The data storage device of claim 1, wherein the controller is further configured to, upon updating the data structure:
determine whether a link state between the data storage device and a host has changed, and
if the link state between the data storage device and the host has changed, copy the contents of the updated data structure into the non-volatile solid-state device.

5. The data storage device of claim 4, wherein the link state between the data storage device and the host is broken.

6. The data storage device of claim 1, wherein the controller is further configured to, upon updating the data structure:
receive a host command to go into a sleep state or a lower power state, and
upon receiving the host command to go into the sleep state or the lower power state, copy the contents of the updated data structure into the non-volatile solid-state device.

7. The data storage device of claim 1, wherein the controller is further configured to, upon updating the data structure:
determine whether a power connection to the data storage device has been broken, and if the power connection has been broken, copy the contents of the updated data structure into the non-volatile solid-state device.

8. The data storage device of claim 1, wherein the host command to flush the updated data structure is included in a field of a system interface command.

9. The data storage device of claim 8, wherein the system interface command comprises one of a SATA flush cache command, a SATA standby immediate command, a SAS synchronize cache command, an NVMe flush command, or an NVMe shutdown notification command.

10. The data storage device of claim 1, wherein the controller is further configured to, prior to updating the data structure, receive a host command to disable copying the contents of the updated data structure into the non-volatile solid-state device after one of a predetermined time interval or a predetermined number of write commands have been received from the host.

11. The data storage device of claim 1, wherein the controller is further configured to, after copying the contents of the updated data structure into the non-volatile solid-state device, update the flag to indicate the contents of the data structure are consistent with the contents of a corresponding data structure stored in the non-volatile solid-state device.

12. The data storage device of claim 1, wherein the controller is further configured to, upon updating the data structure, determine whether the contents of the data structure are consistent with the contents of a corresponding data structure stored in the non-volatile solid-state device.

13. A method of operating a storage device that includes a non-volatile solid-state device and a volatile solid-state memory device that is configured to store a first data structure that maps logical block addresses stored in the data storage device to respective physical memory locations in the non-volatile solid-state storage device, the method comprising:
determining whether the contents of the first data structure are consistent with the contents of a corresponding second data structure stored in the non-volatile solid-state storage device;
based on the contents of the first data structure being consistent with the contents of a corresponding second data structure, determining whether a host command to flush the first data structure has been received, and
if the host command to flush the first data structure has been received, copying the contents of the first data structure into the non-volatile solid-state device.

14. The method of claim 13, further comprising, prior to determining whether the contents of the first data structure are consistent with the contents of the corresponding second data structure stored, modifying the contents of first data structure.

15. The method of claim 14, further comprising, upon modifying the first data structure:
determining whether a link state between the data storage device and a host has changed, and
if the link state between the data storage device and the host has changed, copying the contents of the modified first data structure into the non-volatile solid-state device.

16. The method of claim 14, further comprising, upon modifying the first data structure:
receiving a host command to go into a sleep state or a lower power state, and
upon receiving the host command to go into the sleep state or the lower power state, copying the contents of the modified first data structure into the non-volatile solid-state device.

17. The method of claim 14, further comprising, upon modifying the first data structure:
determining whether a power connection to the data storage device has been broken, and
if the power connection has been broken, copying the contents of the updated first data structure into the non-volatile solid-state device.

18. The method of claim 14, further comprising, upon modifying the first data structure, updating a value of a flag to indicate the contents of the first data structure are not consistent with the contents of the corresponding second data structure.

19. The method of claim 13, wherein determining whether the contents of the first data structure are consistent with the contents of the corresponding second data structure comprises checking a value of a flag indicating whether the contents of the first data structure are consistent with the contents of the corresponding second data structure.

20. The method of claim 13, wherein the host command to flush the updated first data structure is included in a field of a system interface command.
